(19) United States
(12) Patent Application Publication
(10) Pub. No.: US 2026/0186514 A1
(43) Pub. Date: Jul. 2, 2026

(54) FLUID CONTROL APPARATUS, DIAGNOSTIC PROGRAM FOR FLUID CONTROL APPARATUS, AND DIAGNOSTIC METHOD FOR FLUID CONTROL APPARATUS

(71) Applicant: HORIBA STEC, Co., Ltd., Kyoto-shi (JP)

(72) Inventors: Daisuke HAYASHI, Kyoto-shi (JP); Seiji HIGUCHI, Kyoto-shi (JP); Kotaro TAKIJIRI, Kyoto-shi (JP); Kazuya TOKUNAGA, Kyoto-shi (JP)

(21) Appl. No.: 19/424,581

(22) Filed: Dec. 18, 2025

(30) Foreign Application Priority Data
Dec. 26, 2024 (JP) 2024-229981

(51) Int. Cl. G05D 7/06; G01F 1/36; G01F 15/00

(52) U.S. Cl. CPC G05D 7/0664; G01F 1/36; G01F 15/005

(57) ABSTRACT

A diagnostic mechanism includes: a valve leak difference calculation unit that calculates a valve leak difference that is a difference between a valve leak pressure change model indicating a pressure change due to a valve leak of a fluid control valve and an upstream pressure detected by an upstream pressure sensor or a downstream pressure detected by a downstream pressure sensor; a sensor shift difference calculation unit that calculates a sensor shift difference that is a difference between a sensor shift pressure change model indicating a pressure change due to a sensor shift of the upstream pressure sensor or the downstream pressure sensor and the upstream pressure or the downstream pressure; and a diagnostic unit that compares the valve leak difference with the sensor shift difference to diagnose whether the fluid control valve is abnormal or whether each of the pressure sensors is abnormal.

### CROSS-REFERENCE TO RELATED APPLICATION(S)

The present application claims priority to Japanese Patent Application No. 2024-229981 filed Dec. 26, 2024, which is incorporated herein by reference in its entirety.

### BACKGROUND

### Technical Field

The present invention relates to a fluid control apparatus, a diagnostic program for the fluid control apparatus, and a diagnostic method for the fluid control apparatus.

### Description of the Related Art

A conventional fluid control apparatus, as shown in, for example, JP 2019-028747 A, includes: a fluid resistance provided in a flow path; a downstream valve provided downstream of the fluid resistance; an upstream pressure sensor that detects an upstream pressure of the fluid resistance; and a downstream pressure sensor that detects a downstream pressure, which is a pressure between the fluid resistance and the downstream valve.

In this type of fluid control apparatus, a first flow rate flowing through the fluid resistance is calculated based on the upstream pressure and the downstream pressure, and a second flow rate flowing out of the downstream valve is calculated based on the first flow rate and the converted flow rate calculated from the time variation of the downstream pressure. Then, a diagnostic unit provided in the fluid control apparatus compares the first flow rate with the second flow rate in a state where the downstream valve is closed to diagnose whether an abnormality is present in the fluid control apparatus.

### PRIOR ART DOCUMENT

### Patent Document

Patent Document 1: JP 2019-028747 A

### SUMMARY

Here, examples of the abnormality of the fluid control apparatus include an abnormality of fluid resistance, an abnormality of a fluid control valve, and/or an abnormality of a pressure sensor. However, in the above fluid control apparatus, the diagnostic unit can diagnose whether an abnormality is present in the fluid control apparatus but cannot diagnose an abnormality of which device of the fluid control apparatus is that abnormality. In particular, in the above fluid control apparatus, it is not possible to diagnose whether the abnormality of the fluid control apparatus is an abnormality of each of the pressure sensors.

Therefore, the present invention has been made in view of the problems as described above, and the main object of the present invention is to provide a fluid control apparatus capable of diagnosing whether an abnormality of the fluid control apparatus is an abnormality of each of the pressure sensors.

That is, a fluid control apparatus according to the present invention includes: a fluid resistance provided in a flow path; an upstream pressure sensor that detects an upstream pressure of the fluid resistance; a downstream pressure sensor that detects a downstream pressure of the fluid resistance; a first flow rate calculation unit that calculates, based on the upstream pressure and the downstream pressure, a first flow rate flowing through the fluid resistance; a fluid control valve provided upstream of the upstream pressure sensor or downstream of the downstream pressure sensor; a valve control unit that controls the fluid control valve based on the first flow rate; and a diagnostic mechanism that diagnoses an abnormality of the fluid control valve and/or each of the pressure sensors in a state where the fluid control valve is closed. The diagnostic mechanism includes a sensor shift difference calculation unit that calculates a sensor shift difference that is a difference between a sensor shift pressure change model and the upstream pressure detected by the upstream pressure sensor or the downstream pressure detected by the downstream pressure sensor, the sensor shift pressure change model indicating a pressure change due to a sensor shift of the upstream pressure sensor or the downstream pressure sensor, and a diagnostic unit that diagnoses, based on the sensor shift difference, whether each of the pressure sensors is abnormal.

In such a fluid control apparatus, the diagnostic unit diagnoses whether each of the pressure sensors is abnormal based on the sensor shift difference, so that it is possible to diagnose whether the abnormality of the fluid control apparatus is an abnormality of each of the pressure sensors or another abnormality.

In addition, since the diagnostic unit uses the sensor shift difference, it is possible to diagnose whether the abnormality is an abnormality of each of the pressure sensors or another abnormality in a shorter time than the case of using the pressure change obtained from the sensor shift pressure change model.

The diagnostic mechanism further includes a valve leak difference calculation unit that calculates a valve leak difference that is a difference between a valve leak pressure change model and the upstream pressure detected by the upstream pressure sensor or the downstream pressure detected by the downstream pressure sensor, the valve leak pressure change model indicating a pressure change due to a valve leak of the fluid control valve, and the diagnostic unit compares the valve leak difference with the sensor shift difference to diagnose whether the fluid control valve is abnormal or whether each of the pressure sensors is abnormal.

With this configuration, since the diagnostic unit compares the valve leak difference with the sensor shift difference to diagnose whether the fluid control valve is abnormal or whether each of the pressure sensors is abnormal, it is possible to diagnose whether the abnormality of the fluid control apparatus is an abnormality of the fluid control valve or an abnormality of each of the pressure sensors.

In addition, since the diagnostic unit compares the valve leak difference with the sensor shift difference, it is possible to diagnose whether the abnormality is an abnormality of the fluid control valve or an abnormality of each of the pressure sensors in a shorter time than the case of comparing the pressure change obtained from the valve leak pressure change model with the pressure change obtained from the sensor shift pressure change model.

When the diagnostic unit diagnoses that each of the pressure sensors is abnormal, the diagnostic unit obtains a sensor shift amount of the upstream pressure sensor from the sensor shift pressure change model, and the first flow rate calculation unit calculates the first flow rate using an upstream pressure of the upstream pressure sensor corrected by the sensor shift amount.

With this configuration, when it is diagnosed that each of the pressure sensors is abnormal, the sensor shift amount of the upstream pressure sensor is obtained from the sensor shift pressure change model. Therefore, even when an abnormality is present in each of the pressure sensors, the first flow rate calculation unit can accurately calculate the first flow rate in consideration of the influence of the abnormality of each of the pressure sensors.

The diagnostic unit performs a Fourier transform on each of the valve leak difference and the sensor shift difference, compares the Fourier-transformed valve leak difference with the Fourier-transformed sensor shift difference, and diagnoses whether the fluid control valve is abnormal or whether each of the pressure sensors is abnormal.

With this configuration, the difference between the valve leak difference and the sensor shift difference can be clarified by a Fourier transform, and it is possible to easily diagnose whether the abnormality of the fluid control apparatus is an abnormality of the fluid control valve or an abnormality of each of the pressure sensors.

As another aspect for easily diagnosing whether the fluid control valve is abnormal or whether each of the pressure sensors is abnormal, the diagnostic unit compares a square error of the valve leak difference with a square error of the sensor shift difference to diagnose whether the fluid control valve is abnormal or whether each of the pressure sensors is abnormal.

A specific aspect of the valve leak pressure change model is represented by Equation 1 below.

$$P = \frac{1}{b} ( 1 + \frac{2}{a \cdot exp ( 2 b \cdot {c}_{ov} \cdot t ) - 1} ) \qquad [ Equation 1 ]$$

Here, P is pressure and t is time. Further, a, b, and cₒᵥ are coefficients obtained by fitting to the upstream pressure detected by the upstream pressure sensor or the downstream pressure detected by the downstream pressure sensor.

A specific aspect of the sensor shift pressure change model is represented by Equation 2 below.

$$P = \frac{A}{t - {t}_{0}} + B \qquad [ Equation 2 ]$$

Here, P is pressure and t is time. Further, A, B, and t₀ are coefficients obtained by fitting to the upstream pressure detected by the upstream pressure sensor or the downstream pressure detected by the downstream pressure sensor.

The diagnostic mechanism further includes: a second flow rate calculation unit that calculates a second flow rate flowing through the fluid resistance based on a change over time in the upstream pressure in a state where the fluid control valve is closed, and a diagnostic parameter calculation unit that calculates a diagnostic parameter based on the first flow rate calculated by the first flow rate calculation unit in a state where the fluid control valve is closed and the second flow rate calculated by the second flow rate calculation unit, and the diagnostic unit diagnoses an abnormality of the fluid resistance based on the diagnostic parameter, and/or changes a correction coefficient in the flow rate calculation of the first flow rate calculation unit.

With this configuration, the diagnostic unit diagnoses an abnormality of the fluid resistance in addition to the diagnosis of the abnormality of the fluid control valve and/or each of the pressure sensors, so that it is possible to diagnose an abnormality of which device constituting the fluid control apparatus is the abnormality of the fluid control apparatus.

After diagnosing an abnormality of the fluid resistance and/or after changing the correction coefficient, the diagnostic unit diagnoses an abnormality of the fluid control valve and/or an abnormality of each of the pressure sensors.

With this configuration, since the correction coefficient reflects the degree of the abnormality of the fluid resistance when the abnormality of the fluid control valve and/or the abnormality of each of the pressure sensors is diagnosed, the diagnostic unit can accurately diagnose the abnormality of the fluid control valve and/or the abnormality of each of the pressure sensors.

Further, a diagnostic program for a fluid control apparatus according to the present invention is a diagnostic program for a fluid control apparatus including a fluid resistance provided in a flow path, an upstream pressure sensor that detects an upstream pressure of the fluid resistance, a downstream pressure sensor that detects a downstream pressure of the fluid resistance, a first flow rate calculation unit that calculates, based on the upstream pressure and the downstream pressure, a first flow rate flowing through the fluid resistance, a fluid control valve provided upstream of the upstream pressure sensor or downstream of the downstream pressure sensor, and a valve control unit that controls the fluid control valve based on the first flow rate, the diagnostic program diagnosing an abnormality of the fluid control valve and/or an abnormality of each of the pressure sensors in the fluid control apparatus when the fluid control valve is closed. The diagnostic program causes a computer to be provided with: a function as a valve leak difference calculation unit that calculates a valve leak difference that is a difference between a valve leak pressure change model indicating a pressure change due to a valve leak of the fluid control valve and the upstream pressure detected by the upstream pressure sensor or the downstream pressure detected by the downstream pressure sensor; a function as a sensor shift difference calculation unit that calculates a sensor shift difference that is a difference between a sensor shift pressure change model and the upstream pressure detected by the upstream pressure sensor or the downstream pressure detected by the downstream pressure sensor, the sensor shift pressure change model indicating a pressure change due to a sensor shift of the upstream pressure sensor or the downstream pressure sensor; and a function as a diagnostic unit that compares the valve leak difference with the sensor shift difference to diagnose whether the fluid control valve is abnormal or whether each of the pressure sensors is abnormal.

Further, a diagnostic method for a fluid control apparatus according to the present invention is a diagnostic method for a fluid control apparatus including a fluid resistance provided in a flow path, an upstream pressure sensor that detects an upstream pressure of the fluid resistance, a downstream pressure sensor that detects a downstream pressure of the fluid resistance, a first flow rate calculation unit that calculates, based on the upstream pressure and the downstream pressure, a first flow rate flowing through the fluid resistance, a fluid control valve provided upstream of the upstream pressure sensor or downstream of the downstream pressure sensor, and a valve control unit that controls the fluid control valve based on the first flow rate, the diagnostic method being for diagnosing an abnormality of the fluid control valve and/or an abnormality of each of the pressure sensors in the fluid control apparatus when the fluid control valve is closed. The diagnostic method includes: calculating a valve leak difference that is a difference between a valve leak pressure change model indicating a pressure change due to a valve leak of the fluid control valve and the upstream pressure detected by the upstream pressure sensor or the downstream pressure detected by the downstream pressure sensor; calculating a sensor shift difference that is a difference between a sensor shift pressure change model and the upstream pressure detected by the upstream pressure sensor or the downstream pressure detected by the downstream pressure sensor, the sensor shift pressure change model indicating a pressure change due to a sensor shift of the upstream pressure sensor or the downstream pressure sensor; and comparing the valve leak difference with the sensor shift difference to diagnose whether the fluid control valve is abnormal or whether each of the pressure sensors is abnormal.

According to the present invention configured as described above, it is possible to provide the fluid control apparatus capable of diagnosing whether the abnormality of the fluid control apparatus is an abnormality of the fluid control valve or an abnormality of each of the pressure sensors.

### BRIEF DESCRIPTION OF THE DRAWINGS

FIG. 1 is a schematic view illustrating a fluid control apparatus according to an embodiment of the present invention;

FIG. 2 is a graph illustrating a temporal change in a diagnostic parameter of the embodiment;

FIG. 3A is a graph illustrating temporal changes in a valve leak pressure change model, a sensor shift pressure change model, and an upstream pressure when an abnormality is present in the fluid control valve, and FIG. 3B is a graph illustrating temporal changes in a valve leak pressure change model, a sensor shift pressure change model, and an upstream pressure when an abnormality is present in the pressure sensor in the embodiment;

FIG. 4A is a graph illustrating a temporal change in a valve leak difference and a temporal change in a sensor shift difference when an abnormality is present in a fluid control valve, and FIG. 4B is a graph illustrating a temporal change in a valve leak difference and a temporal change in a sensor shift difference when an abnormality is present in the pressure sensor in the embodiment;

FIG. 5 is a flowchart illustrating a diagnostic method for the fluid control apparatus in the embodiment;

FIG. 6 is a graph obtained by performing Fourier transform on a valve leak difference and a sensor shift difference when an abnormality is present in a pressure sensor in another embodiment; and

FIG. 7 is a graph in which a low-pass filter is applied to a valve leak difference and a graph in which a low-pass filter is applied to a sensor shift difference when an abnormality is present in the pressure sensor in another embodiment.

### DETAILED DESCRIPTION

Hereinafter, an embodiment of a fluid control apparatus according to the present invention will be described with reference to the drawings. Note that any of the following drawings may be omitted or exaggerated schematically as appropriate for clarity. The same components are denoted by the same reference numerals, and the description thereof will be omitted as appropriate.

A fluid control apparatus 100 in the present embodiment is used, for example, in a semiconductor manufacturing process or the like, and is provided in one or more gas supply lines to control the flow rate of the process gas flowing through each gas supply line.

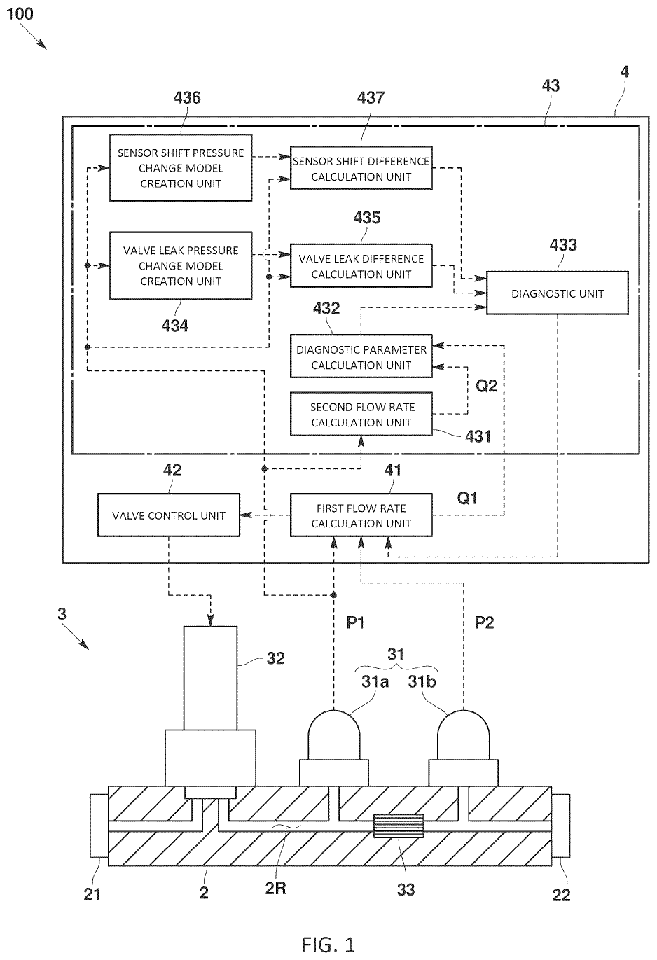

Specifically, the fluid control apparatus 100 is a so-called differential pressure type mass flow controller (differential pressure type MFC), and includes, as illustrated in FIG. 1, a flow path block 2 in which a plurality of internal flow paths 2R are formed, a fluid control device 3 provided in the flow path block 2, and an arithmetic control apparatus 4 that controls the fluid control device 3 and performs various calculations.

The flow path block 2 is provided with an introduction port 21 for introducing a fluid into the internal flow path 2R and a discharge port 22 for discharging the fluid from the internal flow path 2R. An upstream pipe (not illustrated) is connected to the introduction port 21, and an upstream pneumatic valve (not illustrated) is provided in the upstream pipe. A downstream pipe (not illustrated) is connected to the discharge port 22, and a downstream pneumatic valve (not illustrated) is provided in the downstream pipe.

The fluid control device 3 controls the fluid in the internal flow path 2R, and includes a flow rate sensor 31 that measures the flow rate of the fluid flowing through the internal flow path 2R, and a fluid control valve 32 provided upstream of the flow rate sensor 31.

The flow rate sensor 31 is a differential pressure type flow rate sensor, and includes an upstream pressure sensor 31a provided upstream of a fluid resistance 33 provided in the internal flow path 2R and a downstream pressure sensor 31b provided downstream of the fluid resistance 33. Then, a first flow rate calculation unit 41 of the arithmetic control apparatus 4, which will be described later, calculates the flow rate flowing through the internal flow path 2R using an upstream pressure P1 of the fluid resistance 33 detected by the upstream pressure sensor 31a and a downstream pressure P2 of the fluid resistance 33 detected by the downstream pressure sensor 31b. Note that examples of the fluid resistance 33 include a restrictor, an orifice, a nozzle, a venturi tube, and/or a capillary tube.

The fluid control valve 32 is provided upstream of the flow rate sensor 31. Specifically, the fluid control valve 32 controls the flow rate by moving a valve body forward and backward with respect to a valve seat by the piezo actuator. Note that the opening degree of the fluid control valve 32 is feedback-controlled by a valve control unit 42 of the arithmetic control apparatus 4, which will be described later. In the present embodiment, the fluid control valve 32 is provided upstream of the upstream pressure sensor 31a, but may be provided downstream of the downstream pressure sensor 31b.

The arithmetic control apparatus 4 is, for example, a so-called computer including a computer processing unit (CPU), a memory, A/D and D/A converters, and an input/output unit, and exhibits at least a function as the first flow rate calculation unit 41, a function as the valve control unit 42, and a function as a diagnostic mechanism 43, as illustrated in FIG. 1, by executing a program stored in the memory and having various devices cooperate with each other. In the present embodiment, the arithmetic control apparatus 4 is accommodated in a housing that accommodates the fluid control device 3, but the arithmetic control apparatus 4 may be provided outside the housing. Alternatively, only the diagnostic mechanism 43 may be provided outside the housing.

Hereinafter, each unit constituting the arithmetic control apparatus 4 will be described.

The first flow rate calculation unit 41 calculates the flow rate (first flow rate Q1) of the fluid flowing through the fluid resistance based on the upstream pressure P1 and the downstream pressure P2. Specifically, the first flow rate calculation unit 41 calculates a differential pressure ΔP between the upstream pressure P1 and the downstream pressure P2, and calculates the first flow rate Q1 by multiplying the differential pressure ΔP by a predetermined coefficient. At this time, it is assumed that a predetermined fluid flows through the fluid resistance 33.

The valve control unit 42 controls the fluid control valve 32 based on the first flow rate Q1. In the present embodiment, the valve control unit 42 controls the opening degree of the fluid control valve 32 based on the first flow rate Q1.

The diagnostic mechanism 43 diagnoses abnormalities of the fluid resistance 33, the fluid control valve 32, and/or each of the pressure sensors 31a, 31b in a state where the fluid control valve 32 is closed.

Specifically, as illustrated in FIG. 1, the diagnostic mechanism 43 includes a second flow rate calculation unit 431, a diagnostic parameter calculation unit 432, a diagnostic unit 433, a valve leak pressure change model creation unit 434, a valve leak difference calculation unit 435, a sensor shift pressure change model creation unit 436, and a sensor shift difference calculation unit 437.

In the present embodiment, the diagnostic mechanism 43 diagnoses an abnormality of the fluid resistance 33 in a state where the fluid control valve 32 is closed, and then diagnoses abnormalities of the fluid control valve 32 and/or each of the pressure sensors 31a, 31b. Hereinafter, among functional units constituting the diagnostic mechanism 43, first, a functional unit that diagnoses an abnormality of the fluid resistance 33 will be described.

The second flow rate calculation unit 431 calculates the flow rate (second flow rate Q2) of the fluid flowing through the fluid resistance based on a change over time in the upstream pressure P1 in the state where the fluid control valve 32 is closed. Specifically, the second flow rate Q2 is a flow rate obtained by time-differentiating a gas state equation solved for the upstream pressure P1 in a state where the fluid control valve 32 is closed. Even more specifically, the second flow rate Q2 is expressed as a product of at least a time differentiation performed on a gas equation of state that has been solved for the upstream-side pressure P1 and an internal volume. Here, ‘internal volume’ refers to a space in the internal flow path 2R from a valve seat surface of the fluid control valve 32 to an upstream-side end portion of the fluid resistor 33. Note that the temporal change in the upstream pressure P1 when the second flow rate Q2 is calculated is not limited to a value obtained by differentiation, and examples thereof include a difference value of the upstream pressure P1 at two time points after the time when the fluid control valve 32 is closed.

The diagnostic parameter calculation unit 432 calculates the diagnostic parameter based on the first flow rate Q1 calculated by the first flow rate calculation unit 41 and the second flow rate Q2 calculated by the second flow rate calculation unit 431 in a state where the fluid control valve 32 is closed. The diagnostic parameter is a value obtained using a ratio between the first flow rate Q1 and the second flow rate Q2. Specifically, the diagnostic parameter is expressed by Equation 3 below. The state in which the fluid control valve 32 is closed refers to a state in which the fluid control valve 32 is closed from a state in which the fluid is flowing in the internal flow path 2R. In the state where the fluid control valve 32 is closed, the fluid has been drained downstream of the fluid control valve 32, and the fluid has accumulated upstream of the fluid control valve 32.

$$S = 1 - \frac{Q 1}{Q 2} \qquad [ Equation 3 ]$$

Here, S is a diagnostic parameter, Q1 is a first flow rate, and Q2 is a second flow rate. Note that it is necessary that the internal volume, which is one of the parameters constituting the second flow rate Q2, be determined before the fluid control apparatus 100 is used. Because of this, when the fluid control apparatus 100 is manufactured, the internal volume is measured so that the diagnostic parameter becomes 0.

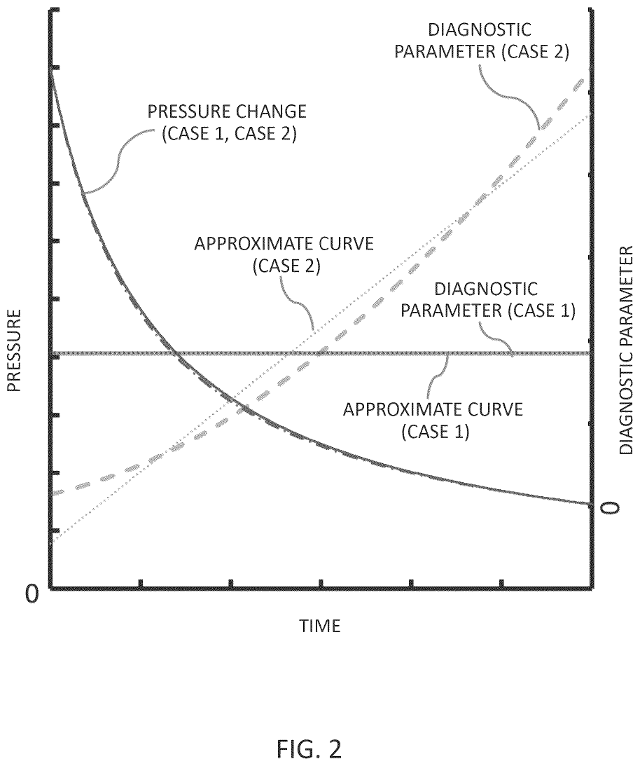

In the present embodiment, the diagnostic parameter calculation unit 432 calculates a diagnostic parameter over a predetermined period. Specifically, as illustrated in FIG. 2, the diagnostic parameter calculation unit 432 calculates a diagnostic parameter in a period from when the fluid control valve 32 is closed until the upstream pressure P1 falls and converges to a predetermined value.

The diagnostic unit 433 diagnoses an abnormality of the fluid resistance 33 based on the diagnostic parameter and/or changes a correction coefficient in the flow rate calculation of the first flow rate calculation unit 41. In the present embodiment, the diagnostic unit 433 diagnoses an abnormality of the fluid resistance 33 and/or changes the correction coefficient in the flow rate calculation of the first flow rate calculation unit 41 based on the value of the diagnostic parameter or the temporal change in the diagnostic parameter during a predetermined period from the time when the fluid control valve 32 is closed. Specifically, the diagnostic unit 433 calculates an approximate curve approximating a temporal change in the diagnostic parameter during the predetermined period, diagnoses an abnormality of the fluid resistance 33 based on the value of the diagnostic parameter and/or the approximate curve thereof, and/or changes the correction coefficient in the flow rate calculation of the first flow rate calculation unit 41. Here, the value of the diagnostic parameter includes, for example, a value obtained as an average value of a plurality of points of the ratio between the first flow rate Q1 and the second flow rate Q2 after the time when the fluid control valve 32 is closed, an intercept value of an approximate curve of the diagnostic parameter, or the like, in addition to the value itself of the diagnostic parameter during a predetermined period from the time when the fluid control valve 32 is closed or the time when the fluid control valve is closed.

More specifically, when the diagnostic parameter is constant within a predetermined range including zero during a predetermined period, the diagnostic unit 433 diagnoses that the fluid resistance 33 is normal. As illustrated in FIG. 2, when the diagnostic parameter is outside the predetermined range including zero during the predetermined period and the slope of the approximate curve of the diagnostic parameter is within the predetermined range, the diagnostic unit 433 diagnoses that the fluid resistance 33 is abnormal. Note that examples of the case in which the slope of the approximate curve of the diagnostic parameter is within the predetermined range can be, for example, a case in which the slope of the approximate curve is zero or substantially zero.

When the diagnostic unit 433 determines that the fluid resistance 33 is abnormal, and when the value of the diagnostic parameter is a positive value during the predetermined period, the diagnostic unit 433 can determine that the abnormality of the fluid resistance 33 is a leakage of the fluid resistance 33. When the value of the diagnostic parameter is a negative value during the predetermined period, the diagnostic unit 433 can determine that the abnormality of the fluid resistance 33 is a clogging of the fluid resistance 33.

FIG. 2 illustrates a pressure change, a change over time in the diagnostic parameter, and an approximate curve when an abnormality is present in the fluid resistance 33 (case 1) and when an abnormality is present in the fluid control device 3 other than the fluid resistance (case 2). As illustrated in FIG. 2, since the pressure change in case 1 and the pressure change in case 2 (an alternate long and short dashed line in FIG. 2) are substantially the same after the time when the fluid control valve 32 is closed, it is not possible to diagnose an abnormality of which device is the abnormality of the fluid control apparatus 100 by using only the pressure change in case 1 and the pressure change in case 2.

Therefore, when the diagnostic parameters and the approximate curve are calculated, it is possible to diagnose whether the abnormality in each of case 1 and the abnormality in case 2 is an abnormality of the fluid resistance 33 or an abnormality of the fluid control device 3 other than the fluid resistance 33. In FIG. 2, the diagnostic parameter is indicated by a solid line, and the approximate curve of the diagnostic parameter is indicated by a dotted line. Specifically, in case 1, the diagnostic parameter at the time when the fluid control valve 32 is closed is outside the predetermined range including zero, and the slope of the approximate curve of the diagnostic parameter during the predetermined period is within the predetermined range. Here, it can be diagnosed that the abnormality in case 1 is an abnormality of the fluid resistance 33.

On the other hand, in case 2, the diagnostic parameter at the time when the fluid control valve 32 is closed is within the predetermined range including zero, and the slope of the approximate curve of the diagnostic parameter during the predetermined period is outside the predetermined range. Here, it can be diagnosed that the fluid resistance 33 is normal and that the abnormality in case 2 is an abnormality of the fluid control device 3 other than the fluid resistance 33.

When the diagnostic parameter at the time when the fluid control valve 32 is closed is outside the predetermined range including zero and the slope of the approximate curve of the diagnostic parameter during the predetermined period is outside the predetermined range, it can be diagnosed that the abnormality is an abnormality of the fluid control device 3 other than the fluid resistance 33 in addition to the abnormality of the fluid resistance 33. When the diagnostic parameter at the time when the fluid control valve 32 is closed is within the predetermined range including zero and the slope of the approximate curve of the diagnostic parameter during the predetermined period is within the predetermined range, it can be diagnosed that the fluid resistance 33 and the fluid control device 3 other than the fluid resistance 33 are normal.

In the present embodiment, when the diagnostic unit 433 diagnoses that the fluid resistance 33 is abnormal, the diagnostic unit 433 can change the correction coefficient in the flow rate calculation of the first flow rate calculation unit 41. In the present embodiment, the correction coefficient is changed by multiplying an initial correction coefficient indicating a ratio between a flow rate of a reference device and a flow rate of a comparator by a value obtained from the first flow rate Q1 and the second flow rate Q2. In the present embodiment, the value obtained from the first flow rate Q1 and the second flow rate Q2 is the ratio between the first flow rate Q1 and the second flow rate Q2.

A method of calculating and changing the correction coefficient will be described. First, for example, in an initial state such as at the time of shipment of the fluid control apparatus 100, the fluid control device 3 calculates a ratio between the flow rate calculated by the calibrated reference device and the flow rate calculated by the fluid control apparatus 100 to calculate an initial correction coefficient.

Next, in a first diagnosis, the correction coefficient is changed by calculating the ratio between the first flow rate Q1 and the second flow rate Q2 and multiplying the initial correction coefficient by the ratio. When the first diagnosis is completed, the first flow rate calculation unit 41 calculates the flow rate by using, as a correction coefficient, a value obtained by multiplying the initial correction coefficient by the ratio between the first flow rate Q1 and the second flow rate Q2.

Next, in a second diagnosis, the correction coefficient is changed by calculating the ratio between the first flow rate Q1 and the second flow rate Q2 and multiplying the correction coefficient by the ratio. As a result, the correction coefficient is obtained by multiplying the initial correction coefficient, the ratio calculated in the first diagnosis, and the ratio calculated in the second diagnosis. When the second diagnosis is completed, the first flow rate calculation unit 41 calculates the flow rate using the correction coefficient changed by the second diagnosis.

In third and subsequent diagnoses, similarly to the second diagnosis, the ratio between the first flow rate Q1 and the second flow rate Q2 is calculated, and the correction coefficient changed in the previous diagnosis is multiplied by the ratio to change the correction coefficient.

Here, the ratio between the first flow rate Q1 and the second flow rate Q2 used for changing the correction coefficient may be changed according to the slope of the approximate curve of the diagnostic parameter. For example, when the slope of an approximate curve of the diagnostic parameter is outside a predetermined range, the ratio between the first flow rate Q1 and the second flow rate Q2 used for changing the correction coefficient may be a ratio between the first flow rate Q1 and the second flow rate Q2 at the time when the fluid control valve 32 is closed or after a lapse of a predetermined period from the time when the fluid control valve 32 is closed, or a value obtained by subtracting an intercept value of the approximate curve of the diagnostic parameter from 1. On the other hand, when the slope of an approximate curve of the diagnostic parameter is within a predetermined range, the ratio between the first flow rate Q1 and the second flow rate Q2 used for changing the correction coefficient may be an average value of ratios between the first flow rate Q1 and the second flow rate Q2 at a plurality of points after the time when the fluid control valve 32 is closed, or a value obtained by subtracting an intercept value of the approximate curve of the diagnostic parameter from 1.

Next, among the units constituting the diagnostic mechanism 43, the units that diagnose abnormalities of the fluid control valve 32 and/or each of the pressure sensors 31a, 31b will be described.

The valve leak pressure change model creation unit 434 creates a valve leak pressure change model indicating a pressure change due to a valve leak of the fluid control valve 32. The valve leak pressure change model is a model that makes it possible to diagnose that the fluid control valve 32 is abnormal when the model matches the pressure detected by each of the pressure sensors 31a, 31b.

To create the valve leak pressure change model, first, the valve leak pressure change model creation unit 434 acquires the upstream pressure P1 detected by the upstream pressure sensor 31a over a predetermined period, for example, from 0 seconds to 3 seconds. Then, the valve leak pressure change model creation unit 434 creates a valve leak pressure change model by fitting Equation 5, obtained by solving a differential equation expressed by Equation 4 below, to the upstream pressure P1 detected by the upstream pressure sensor 31a. Note that the valve leak pressure change model creation unit 434 may create the valve leak pressure change model by fitting to the downstream pressure P2 detected by the downstream pressure sensor 31b.

$$\frac{d P}{d t} = - k {P}^{2} + {c}_{o ν} \qquad [ Equation 4 ]$$

In Equation 4, P is pressure, and k and cₒᵥ are predetermined coefficients. In the case of valve leakage, since the pressure change rate of the upstream pressure P1 is shifted compared to the normal time, Equation 4 assumes that the shift amount of the pressure change rate is cₒᵥ, the downstream pressure P2 is 0, and the change over time in the upstream pressure P1 is a model.

$$P = \frac{1}{b} ( 1 + \frac{2}{α \cdot exp ( 2 b \cdot {c}_{ov} \cdot t ) - 1} ) \qquad [ Equation 5 ]$$

In Equation 5, P is pressure and t is time. Further, a, b, and cₒᵥ are coefficients obtained by fitting to the upstream pressure P1 detected by the upstream pressure sensor 31a.

The valve leak difference calculation unit 435 calculates a valve leak difference that is a difference between the valve leak pressure change model and the upstream pressure P1 detected by the upstream pressure sensor 31a. Note that the valve leak difference calculation unit 435 may set, as the valve leak difference, a difference between the valve leak pressure change model and the downstream pressure P2 detected by the downstream pressure sensor 31b.

To calculate the valve leak difference, the valve leak difference calculation unit 435 first acquires the valve leak pressure change model from the valve leak pressure change model creation unit 434, and acquires the upstream pressure P1 from the upstream pressure sensor 31a. Then, the valve leak difference calculation unit 435 calculates a difference between the valve leak pressure change model and the upstream pressure P1 to obtain a valve leak difference.

The sensor shift pressure change model creation unit 436 creates a sensor shift pressure change model indicating a pressure change due to a sensor shift of the upstream pressure sensor 31a or the downstream pressure sensor 31b. The sensor shift pressure change model is a model that makes it possible to diagnose that each of the pressure sensors 31a, 31b is abnormal when the model matches the pressure detected by each of the pressure sensors 31a, 31b.

To create the sensor shift pressure change model, first, the sensor shift pressure change model creation unit 436 acquires the upstream pressure P1 detected by the upstream pressure sensor 31a over a predetermined period, for example, from 0 seconds to 3 seconds. Then, the sensor shift pressure change model creation unit 436 creates the sensor shift pressure change model by fitting Equation 7, obtained by solving a differential equation represented by Equation 6 below, to the upstream pressure P1 detected by the upstream pressure sensor 31a. Note that the sensor shift pressure change model creation unit 436 may create the sensor shift pressure change model by fitting to the downstream pressure P2 detected by the downstream pressure sensor 31b.

$$\frac{dP}{dt} = - {kP}^{2} \qquad [ Equation 6 ]$$

In Equation 6, P is pressure, and k is a predetermined coefficient.

$$P = \frac{A}{t - {t}_{0}} + B \qquad [ Equation 7 ]$$

In Equation 7, P is pressure and tis time. Further, A, B, and t₀ are coefficients obtained by fitting to the upstream pressure P1 detected by the upstream pressure sensor 31a.

Here, in the case of the sensor shift, the upstream pressure P1 only shifts as a whole, and the pressure change rate of the upstream pressure P1 is substantially the same as that at the normal time. Therefore, the sensor shift pressure change model is represented by Equation 6, and the shift amount is represented by B, which is an integral constant of Equation 7.

The sensor shift difference calculation unit 437 calculates a sensor shift difference that is a difference between the sensor shift pressure change model and the upstream pressure P1 detected by the upstream pressure sensor 31a. The sensor shift difference makes it possible to diagnose an abnormality of the fluid control valve 32 in a shorter time than the sensor shift pressure change model. Note that the sensor shift difference calculation unit 437 may use, as the sensor shift difference, a difference between the sensor shift pressure change model and the downstream pressure P2 detected by the downstream pressure sensor 31b.

To calculate the sensor shift difference, the sensor shift difference calculation unit 437 first acquires the sensor shift pressure change model from the sensor shift pressure change model creation unit 436, and acquires the upstream pressure P1 from the upstream pressure sensor 31a. Then, the sensor shift difference calculation unit 437 calculates, as a sensor shift difference, a difference between the sensor shift pressure change model and the upstream pressure P1.

After diagnosing an abnormality of the fluid resistance 33 and/or changing the correction coefficient, the diagnostic unit 433 diagnoses an abnormality of the fluid control valve 32 and/or an abnormality of each of the pressure sensors 31a, 31b.

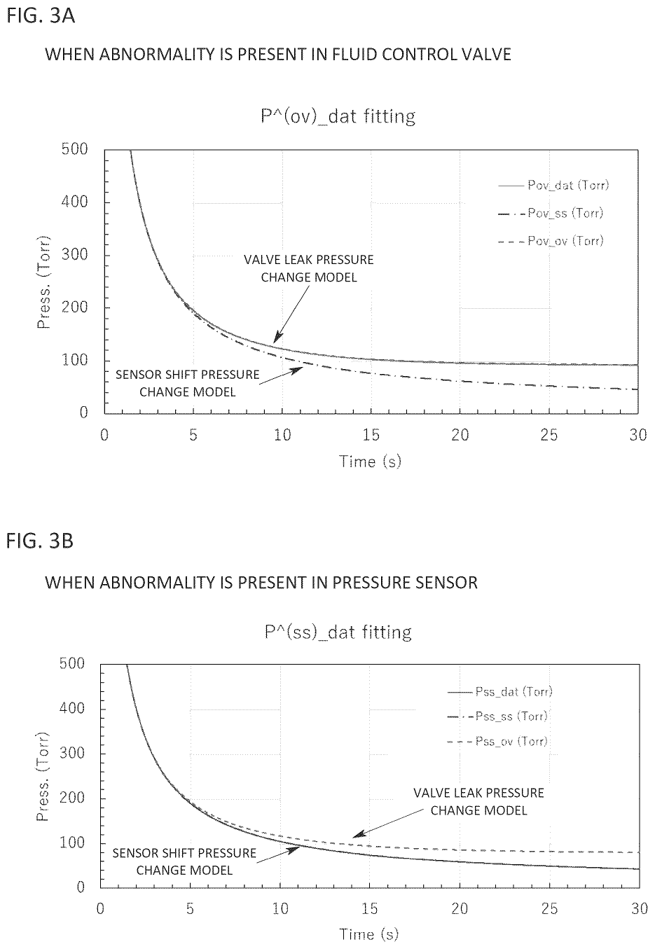

Here, as illustrated in FIG. 3A, when the pressure change obtained from the valve leak pressure change model matches the temporal change in the upstream pressure P1 detected by the upstream pressure sensor 31a, the diagnostic unit 433 can diagnose that the fluid control valve 32 is abnormal. Specifically, as illustrated in FIG. 3A, when the pressure change obtained from the valve leak pressure change model matches the temporal change in the upstream pressure P1 over a predetermined period, and the pressure change obtained from the sensor shift pressure change model deviates from the upstream pressure P1 with the lapse of time, the diagnostic unit 433 can diagnose that the fluid control valve 32 is abnormal.

On the other hand, as illustrated in FIG. 3B, when the pressure change obtained from the sensor shift pressure change model matches the temporal change in the upstream pressure P1 detected by the upstream pressure sensor 31a, the diagnostic unit 433 can diagnose that each of the pressure sensors 31a, 31b is abnormal. Specifically, as illustrated in FIG. 3B, when the pressure change obtained from the sensor shift pressure change model matches the temporal change in the upstream pressure P1 over a predetermined period and the valve leak pressure change model deviates from the upstream pressure P1 with the lapse of time, the diagnostic unit 433 can diagnose that each of the pressure sensors 31a, 31b is abnormal.

By the way, the diagnostic unit 433 can diagnose the abnormality in a shorter time by comparing the valve leak difference with the sensor shift difference than by comparing the pressure change obtained from the valve leak pressure change model with the pressure change obtained from the sensor shift pressure change model. Therefore, in the present embodiment, after diagnosing an abnormality of the fluid resistance 33 and/or after changing the correction coefficient, the diagnostic unit 433 compares the valve leak difference with the sensor shift difference to diagnose an abnormality of the fluid control valve 32 and/or an abnormality of each of the pressure sensors 31a, 31b. Specifically, the diagnostic unit 433 diagnoses that an abnormality of the device corresponding to the smaller one of the valve leak difference and the sensor shift difference has occurred.

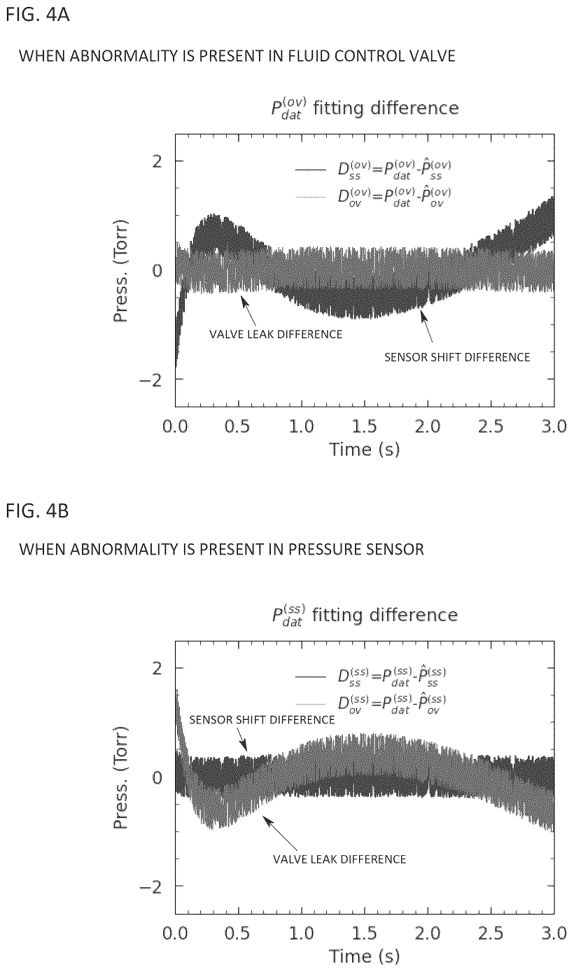

More specifically, the diagnostic unit 433 acquires a valve leak difference and a sensor shift difference during a predetermined period. As illustrated in FIG. 4A, when the valve leak difference is smaller than the sensor shift difference, the diagnostic unit 433 diagnoses that the fluid control valve 32 is abnormal. On the other hand, as illustrated in FIG. 4B, when the sensor shift difference is smaller than the valve leak difference, the diagnostic unit 433 diagnoses that the upstream pressure sensor 31a is abnormal.

Moreover, when the diagnostic unit 433 diagnoses that the upstream pressure sensor 31a is abnormal, the diagnostic unit 433 obtains the sensor shift amount of the upstream pressure sensor 31a from the sensor shift pressure change model. The sensor shift amount mentioned here is an amount indicating a deviation of the upstream pressure sensor 31a from the time of calibration, and more specifically, is the value of the constant term of the sensor shift pressure change model (the value represented by B in Equation 7).

Then, the diagnostic unit 433 outputs the sensor shift amount to the first flow rate calculation unit 41. The first flow rate calculation unit 41 calculates the first flow rate Q1 by adding the sensor shift amount to the differential pressure ΔP between the upstream pressure P1 and the downstream pressure P2.

### <Diagnostic Method for Fluid Control Apparatus>

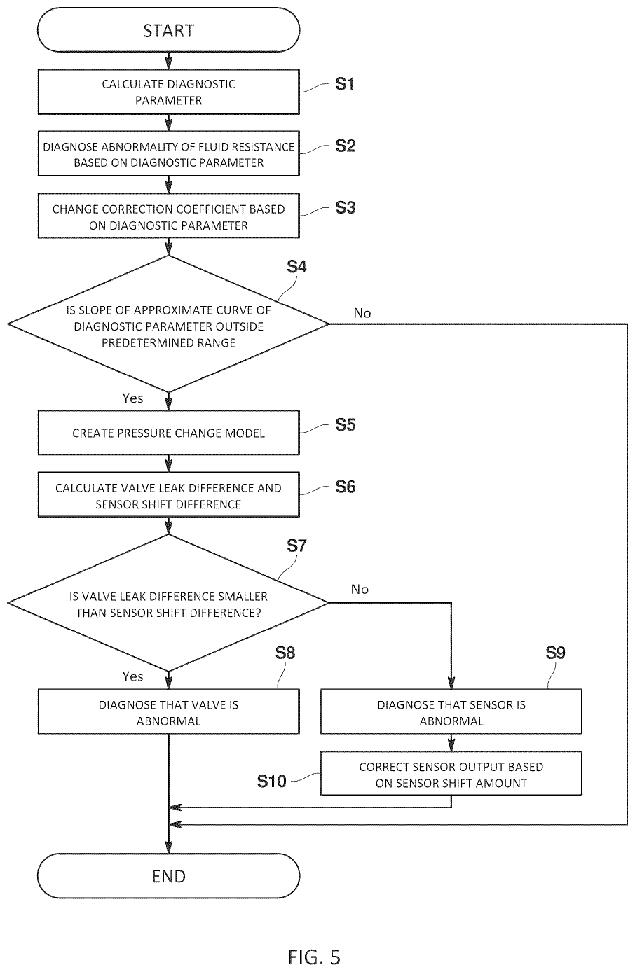

Next, a diagnostic method for the fluid control apparatus 100 according to the present embodiment will be described with reference to FIG. 5.

First, in a state where the fluid control valve 32 is closed, the first flow rate calculation unit 41 calculates the first flow rate Q1, and the second flow rate calculation unit 431 calculates the second flow rate Q2. Then, the diagnostic parameter calculation unit 432 calculates a diagnostic parameter based on the first flow rate Q1 and the second flow rate Q2 (S1). Note that the diagnostic parameter calculation unit 432 calculates the diagnostic parameter over a predetermined period.

Next, the diagnostic unit 433 diagnoses an abnormality of the fluid resistance 33 based on the diagnostic parameter (S2). Specifically, diagnostic unit 433 calculates an approximate curve of a diagnostic parameter during a predetermined period, and based on the approximate curve, diagnoses whether an abnormality is present in the fluid resistance 33 and/or diagnoses a type of abnormality of fluid resistance 33.

Next, when an abnormality is present in the fluid resistance 33, the diagnostic unit 433 changes the correction coefficient in the flow rate calculation of the first flow rate calculation unit 41 based on the diagnostic parameter (S3). When there is no abnormality in the fluid resistance 33, the diagnostic unit 433 may not change the correction coefficient in the flow rate calculation of the first flow rate calculation unit 41. Further, for example, in the case of replacement of the fluid resistance 33 or other cases, the diagnostic unit 433 may not change the correction coefficient even when there is an abnormality in the fluid resistance 33.

Next, the diagnostic unit 433 diagnoses whether an abnormality is present in the fluid control valve 32 and/or each of the pressure sensors 31a, 31b based on the slope of the approximate curve of the diagnostic parameter during the predetermined period (S4). When the slope of the approximate curve of the diagnostic parameter is within the predetermined range, the diagnostic unit 433 terminates the diagnosis of the fluid control apparatus 100. Note that the process may proceed to the next flow regardless of whether the slope of the approximate curve is within the predetermined range.

On the other hand, when the slope of the approximate curve of the diagnostic parameter is outside the predetermined range, the diagnostic unit 433 diagnoses that an abnormality is present in the fluid control valve 32 and/or each of the pressure sensors 31a, 31b. Then, the valve leak pressure change model creation unit 434 acquires the upstream pressure P1 and creates a valve leak pressure change model, and the sensor shift pressure change model creation unit 436 acquires the upstream pressure P1 and creates a sensor shift pressure change model (S5).

When the valve leak pressure change model is created, the valve leak difference calculation unit 435 calculates a valve leak difference based on the valve leak pressure change model and the upstream pressure P1. When the sensor shift pressure change model is created, the sensor shift difference calculation unit 437 calculates a sensor shift difference based on the sensor shift pressure change model and the upstream pressure P1 (S6).

Next, the diagnostic unit 433 compares the valve leak difference with the sensor shift difference to diagnose whether the fluid control valve 32 is abnormal or whether each of the pressure sensors 31a, 31b is abnormal (S7). Specifically, the diagnostic unit 433 compares the magnitudes of the valve leak difference and the sensor shift difference to diagnose whether the fluid control valve 32 is abnormal or whether each of the pressure sensors 31a, 31b is abnormal.

When the valve leak difference is smaller than the sensor shift difference, the diagnostic unit 433 diagnoses that the fluid control valve 32 is abnormal (S8). Then, the diagnostic unit 433 terminates the diagnosis of the fluid control apparatus 100.

On the other hand, when the sensor shift difference is smaller than the valve leak difference, the diagnostic unit 433 diagnoses that each of the pressure sensors 31a, 31b is abnormal (S9).

When diagnosing that each of the pressure sensors 31a, 31b is abnormal, the diagnostic unit 433 obtains the sensor shift amount of the upstream pressure sensor 31a from the sensor shift pressure change model and corrects, based on the sensor shift amount, the upstream pressure P1 output from the upstream pressure sensor 31a (S10). Then, the diagnostic unit 433 terminates the diagnosis of the fluid control apparatus 100.

### Effects of Present Embodiment

According to the fluid control apparatus 100 of the present embodiment, since the diagnostic unit 433 compares the valve leak difference with the sensor shift difference to diagnose whether the fluid control valve 32 is abnormal or whether each of the pressure sensors 31a, 31b is abnormal, the diagnostic unit 433 can diagnose whether the fluid resistance 33 is abnormal, whether the fluid control valve 32 is abnormal, or whether each of the pressure sensors 31a, 31b is abnormal.

In the present embodiment, it is possible to diagnose an abnormality of the fluid resistance 33 using the diagnostic parameter calculated based on the first flow rate Q1 and the second flow rate Q2, which are two flow rates flowing through the fluid resistance in a state where the fluid control valve 32 is closed. Moreover, when the fluid resistance 33 is abnormal, the diagnostic unit 433 can change, based on the diagnostic parameter, the correction coefficient in the flow rate calculation of the first flow rate calculation unit 41.

### OTHER EMBODIMENTS

Note that the present invention is not limited to the above embodiment.

In the above embodiment, the diagnostic unit 433 has diagnosed whether the fluid resistance 33 is abnormal, whether the fluid control valve 32 is abnormal, or whether each of the pressure sensors 31a, 31b is abnormal. However, the diagnostic unit 433 may diagnose only whether the fluid control valve 32 is abnormal or whether each of the pressure sensors 31a, 31b is abnormal.

In the above embodiment, the fluid control valve 32 has been provided upstream of each of the pressure sensors 31a, 31b, and the diagnostic unit 433 has performed the diagnosis based on the falling of the pressure after the time when the fluid control valve 32 is closed. However, the present invention is not limited thereto. For example, the fluid control valve 32 may be provided downstream of each of the pressure sensors 31a, 31b, and the diagnostic unit 433 may make a diagnosis based on the rise of the pressure after the time when the fluid control valve 32 is closed.

In the above embodiment, the diagnostic unit 433 has diagnosed an abnormality of the fluid resistance 33 based on the diagnostic parameter. However, the correction coefficient may be changed without diagnosing an abnormality of the fluid resistance 33.

To easily diagnose whether the fluid control valve is abnormal or whether each of the pressure sensors is abnormal, the diagnostic unit 433 may perform a Fourier transform on each of the valve leak difference and the sensor shift difference, compare the Fourier-transformed valve leak difference with the Fourier-transformed sensor shift difference, and diagnose whether the fluid control valve 32 is abnormal or whether each of the pressure sensors 31a, 31b is abnormal.

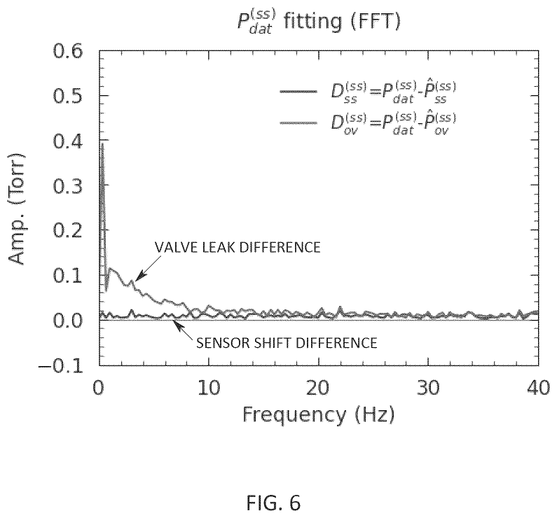

Specifically, the diagnostic unit 433 performs a Fourier transform on each of the valve leak difference and the sensor shift difference. As a result, as illustrated in FIG. 6, in the larger difference, for example, a peak exists at a low frequency in the vicinity of 3 Hz or the like, whereas in the smaller difference, the value after the Fourier transform is in the vicinity of the reference value (e.g., 0) compared to the larger difference. Therefore, the difference between the valve leak difference and the sensor shift difference becomes larger particularly at low frequencies.

As another aspect for easily diagnosing whether the fluid control valve is abnormal or whether each of the pressure sensors is abnormal, the diagnostic unit 433 may compare the square error of the valve leak difference with the square error of the sensor shift difference to diagnose whether the fluid control valve 32 is abnormal or whether each of the pressure sensors 31a, 31b is abnormal.

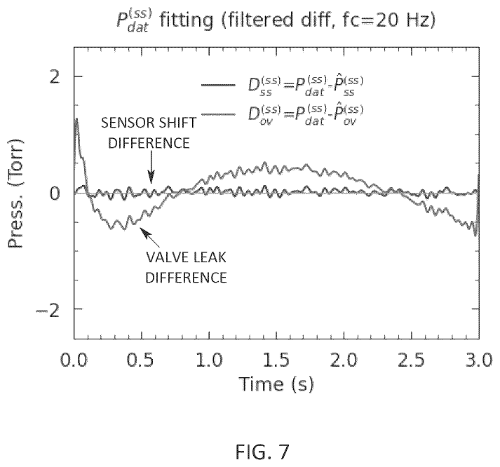

Specifically, the diagnostic unit 433 applies a low-pass filter to each of the valve leak difference and the sensor shift difference to remove high-frequency noise, and then calculates a square error. By applying the low-pass filter, as illustrated in FIG. 7, the difference between the valve leak difference and the sensor shift difference becomes clear, and when the square error is calculated for each difference, the smaller difference is closer to the reference value (e.g., 0), whereas the larger difference is farther from the reference value. Therefore, the difference between the valve leak difference and the sensor shift difference becomes larger.

In the embodiment, the diagnostic parameter has been a value obtained using the ratio between the first flow rate Q1 and the second flow rate Q2, but the diagnostic parameter may be a ratio between the first flow rate Q1 and the second flow rate Q2. In this case, the diagnostic parameter and the correction coefficient have the same value. In the ratio between the first flow rate Q1 and the second flow rate Q2, the first flow rate Q1 may be a numerator and the second flow rate Q2 may be a denominator, or the first flow rate Q1 may be a denominator and the second flow rate Q2 may be a numerator.

In the above embodiment, the diagnostic unit 433 may output an abnormality of the fluid resistance 33, an abnormality of the fluid control valve 32, and/or an abnormality of each of the pressure sensors 31a, 31b to a display unit such as a display.

In the present embodiment, the fluid control apparatus 100 has been a differential pressure type MFC. However, the fluid control apparatus 100 is not limited thereto and may be a so-called thermal mass flow controller, a pressure control device, or another fluid control apparatus.

In the above embodiment, the diagnostic mechanism 43 has been provided with the valve leak pressure change model creation unit 434, the valve leak difference calculation unit 435, the sensor shift pressure change model creation unit 436, and the sensor shift difference calculation unit 437. However, to diagnose whether the abnormality is an abnormality of each of the pressure sensors or another abnormality, the diagnostic mechanism 43 may be provided with at least the sensor shift pressure change model creation unit 436 and the sensor shift difference calculation unit 437. In addition, although each model performs fitting to calculate a coefficient, the coefficient may be obtained using a method other than fitting.

In the present embodiment, the fluid resistance 33 is not limited to the restrictor, and may be, for example, an orifice, a venturi tube, and/or a capillary. In this case, by applying each model according to the type of the fluid resistance 33, it is possible to diagnose whether the fluid control valve is abnormal or whether each of the pressure sensors is abnormal.

In addition, various modifications and combinations of the embodiments may be made without departing from the gist of the present invention.

According to the present invention, it is possible to provide a fluid control apparatus capable of diagnosing whether an abnormality of the fluid control apparatus is an abnormality of a fluid control valve or an abnormality of each of the pressure sensors.

### DESCRIPTION OF REFERENCE CHARACTERS

100 fluid control apparatus
2 flow path block
3 fluid control device
31 pressure sensor
31a upstream pressure sensor
31b downstream pressure sensor
32 fluid control valve
33 fluid resistance
4 arithmetic control apparatus
41 first flow rate calculation unit
42 valve control unit
43 diagnostic mechanism
431 second flow rate calculation unit
432 diagnostic parameter calculation unit
433 diagnostic unit
434 valve leak pressure change model creation unit
435 valve leak difference calculation unit
436 sensor shift pressure change model creation unit
437 sensor shift difference calculation unit
Q1 first flow rate
Q2 second flow rate

What is claimed is:

1. A fluid control apparatus comprising:
a fluid resistance provided in a flow path;
an upstream pressure sensor that detects an upstream pressure of the fluid resistance;
a downstream pressure sensor that detects a downstream pressure of the fluid resistance;
a first flow rate calculation unit that calculates, based on the upstream pressure and the downstream pressure, a first flow rate flowing through the fluid resistance;
a fluid control valve provided upstream of the upstream pressure sensor or downstream of the downstream pressure sensor;
a valve control unit that controls the fluid control valve based on the first flow rate; and
a diagnostic mechanism that diagnoses an abnormality of the fluid control valve and/or each of the pressure sensors in a state where the fluid control valve is closed,
wherein the diagnostic mechanism includes
a sensor shift difference calculation unit that calculates a sensor shift difference that is a difference between a sensor shift pressure change model and the upstream pressure detected by the upstream pressure sensor or the downstream pressure detected by the downstream pressure sensor, the sensor shift pressure change model indicating a pressure change due to a sensor shift of the upstream pressure sensor or the downstream pressure sensor, and
a diagnostic unit that diagnoses, based on the sensor shift difference, whether each of the pressure sensors is abnormal.

2. The fluid control apparatus according to claim 1, wherein
the diagnostic mechanism further includes a valve leak difference calculation unit that calculates a valve leak difference that is a difference between a valve leak pressure change model and the upstream pressure detected by the upstream pressure sensor or the downstream pressure detected by the downstream pressure sensor, the valve leak pressure change model indicating a pressure change due to a valve leak of the fluid control valve, and
the diagnostic unit compares the valve leak difference with the sensor shift difference to diagnose whether the fluid control valve is abnormal or whether each of the pressure sensors is abnormal.

3. The fluid control apparatus according to claim 1, wherein
when the diagnostic unit diagnoses that each of the pressure sensors is abnormal, the diagnostic unit obtains a sensor shift amount of the upstream pressure sensor from the sensor shift pressure change model, and
the first flow rate calculation unit calculates the first flow rate using an upstream pressure of the upstream pressure sensor corrected by the sensor shift amount.

4. The fluid control apparatus according to claim 2, wherein the diagnostic unit performs a Fourier transform on each of the valve leak difference and the sensor shift difference, compares the Fourier-transformed valve leak difference with the Fourier-transformed sensor shift difference, and diagnoses whether the fluid control valve is abnormal or whether each of the pressure sensors is abnormal.

5. The fluid control apparatus according to claim 2, wherein the diagnostic unit compares a square error of the valve leak difference with a square error of the sensor shift difference to diagnose whether the fluid control valve is abnormal or whether each of the pressure sensors is abnormal.

6. The fluid control apparatus according to claim 2, wherein the valve leak pressure change model is expressed by Equation 1 below:
$$P = \frac{1}{b} ( 1 + \frac{2}{α \cdot exp ( 2 b \cdot {c}_{ov} \cdot t ) - 1} ) , \qquad [ Equation 1 ]$$
where P is pressure, and t is time, and a, b, and cₒᵥ are coefficients obtained by fitting to the upstream pressure detected by the upstream pressure sensor or the downstream pressure detected by the downstream pressure sensor.

7. The fluid control apparatus according to claim 1, wherein the sensor shift pressure change model is represented by Equation 2 below:
$$P = \frac{A}{t - {t}_{0}} + B , \qquad [ Equation 2 ]$$
where P is pressure, t is time, and A, B, and t₀ are coefficients obtained by fitting to the upstream pressure detected by the upstream pressure sensor or the downstream pressure detected by the downstream pressure sensor.

8. The fluid control apparatus according to claim 1, wherein
the diagnostic mechanism further includes:
a second flow rate calculation unit that calculates a second flow rate flowing through the fluid resistance based on a change over time in the upstream pressure in a state where the fluid control valve is closed, and
a diagnostic parameter calculation unit that calculates a diagnostic parameter based on the first flow rate calculated by the first flow rate calculation unit in a state where the fluid control valve is closed and the second flow rate calculated by the second flow rate calculation unit, and
the diagnostic unit diagnoses an abnormality of the fluid resistance based on the diagnostic parameter, and/or changes a correction coefficient in the flow rate calculation of the first flow rate calculation unit.

9. The fluid control apparatus according to claim 8, wherein, after diagnosing the abnormality of the fluid resistance and/or after changing the correction coefficient, the diagnostic unit diagnoses an abnormality of the fluid control valve and/or an abnormality of each of the pressure sensors.

10. A non-transitory computer-readable medium storing a diagnostic program for a fluid control apparatus including a fluid resistance provided in a flow path, an upstream pressure sensor that detects an upstream pressure of the fluid resistance, a downstream pressure sensor that detects a downstream pressure of the fluid resistance, a first flow rate calculation unit that calculates, based on the upstream pressure and the downstream pressure, a first flow rate flowing through the fluid resistance, a fluid control valve provided upstream of the upstream pressure sensor or downstream of the downstream pressure sensor, and a valve control unit that controls the fluid control valve based on the first flow rate, the diagnostic program diagnosing an abnormality of the fluid control valve and/or an abnormality of each of the pressure sensors in the fluid control apparatus when the fluid control valve is closed, the diagnostic program being executable by a computer to cause the computer to:
calculate a sensor shift difference that is a difference between a sensor shift pressure change model and the upstream pressure detected by the upstream pressure sensor or the downstream pressure detected by the downstream pressure sensor, the sensor shift pressure change model indicating a pressure change due to a sensor shift of the upstream pressure sensor or the downstream pressure sensor; and
diagnose, based on the sensor shift difference, whether each of the pressure sensors is abnormal.

11. A diagnostic method for a fluid control apparatus including a fluid resistance provided in a flow path, an upstream pressure sensor that detects an upstream pressure of the fluid resistance, a downstream pressure sensor that detects a downstream pressure of the fluid resistance, a first flow rate calculation unit that calculates, based on the upstream pressure and the downstream pressure, a first flow rate flowing through the fluid resistance, a fluid control valve provided upstream of the upstream pressure sensor or downstream of the downstream pressure sensor, and a valve control unit that controls the fluid control valve based on the first flow rate, the diagnostic method being for diagnosing an abnormality of the fluid control valve and/or an abnormality of each of the pressure sensors in the fluid control apparatus when the fluid control valve is closed,
the diagnostic method comprising:
calculating a sensor shift difference that is a difference between a sensor shift pressure change model and the upstream pressure detected by the upstream pressure sensor or the downstream pressure detected by the downstream pressure sensor, the sensor shift pressure change model indicating a pressure change due to a sensor shift of the upstream pressure sensor or the downstream pressure sensor; and
diagnosing, based on the sensor shift difference, whether each of the pressure sensors is abnormal.
